(19) United States
(12) Patent Application Publication
(10) Pub. No.: US 2003/0176997 A1
(43) Pub. Date: Sep. 18, 2003

(54) User interface for a human-computer interaction

(75) Inventor: Wieslawa Wajda, Keltern (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/384,753

(22) Filed: Mar. 11, 2003

(30) Foreign Application Priority Data
Mar. 15, 2002 (EP) 02360090.1

(51) Int. Cl. G06F 17/20

(52) U.S. Cl. 704/8

(57) ABSTRACT

The invention relates to a method for providing a user interface for a human-computer interaction between a user and a terminal, as well as to a computer system, a server and a terminal for executing the method. A general declaratively written description of the human-computer interaction is stored coded in a first descriptive language. An interpreter accesses the stored general description and a terminal-specific data record, which describes the multimodal input possibilities and/or preferences of the terminal. In accordance with the general description of the human-computer interaction and of the terminal's multimodal input possibilities and/or preferences, the interpreter then creates at least one terminal-specific dialog coded in a second descriptive language. The at least one dialog thus created is processed by a control unit.

### TECHNICAL FIELD OF THE INVENTION

The invention is based on a priority application, EP 02360090.1, which is hereby incorporated by reference.

### BACKGROUND OF THE INVENTION

1The invention relates to a method for providing a user interface for a human-computer interaction between a user and a terminal, as well as to a computer system, a server and a terminal for executing the method.

In the description of the presentation and behavior of multimodal human-computer interactions as well as in the implementation of multimodal human-computer interactions, special difficulties arise. Multimodal human-computer interaction means that various modalities are used in parallel for the communication between person and computer. Various modalities are for example communication by text, communication by means of gestures, communication by (spoken) speech or communication by means of other sensory stimuli.

The invention starts from known methods, which use various browsers for a multimodal interaction between human and computer, each of these being responsible for one communication modality. Such a method is described, for example, in the article “Talking heads and synthetic speech: an architecture for supporting electronic commerce”, by J. Ostermann et al, ICME 2000 Proceedings, ISBN: 0-7803-6536-4, page 71-4.

In this method, facial animation is combined with speech synthesis to provide a multimodal user interface. A face model that is used for gesture simulation is downloaded from a server into a client. The client uses an MPEG-4 compatible speech synthesizer. This speech synthesizer is linked to the face model. The gestures of a face shown on the user's screen are controlled by means of the speech synthesizer and the face model. The user communicates with the client through a customary browser, for one thing. For another, the server sends text and animation data to the client in addition to the content that is presented by the web browser. This data is interpreted by the speech synthesizer and the face model, and controls the gestures of the face additionally shown on the screen.

The use of several browsers, each of which is responsible for one modality, demands a complicated synchronization mechanism, which is difficult to implement in practice.

### SUMMARY OF THE INVENTION

The invention is based on the object of specifying an improved method for providing multimodal human-computer interactions.

The invention is achieved with a method for providing a user interface for a human-computer interaction between a user and a terminal, wherein a general declaratively written description of the human-computer interaction is stored coded in a first descriptive language, that an interpreter accesses the stored general description and a terminal-specific data record, which describes the multimodal input possibilities and/or preferences of the terminal and the interpreter according to the general description of the human-computer interaction and the multimodal input possibilities and/or preferences of the terminal creates at least one terminal-specific dialog coded in a second descriptive language, and that the at least one dialog thus created is processed by a control unit.

The invention is further achieved with a computer system with at least one terminal, which is equipped with a user interface for a human-computer interaction between a user and the terminal, wherein the computer system is equipped with a memory unit in which a general declaratively written description of the human-computer interaction is stored coded in a first descriptive language, that the computer system is equipped with an interpreter, which is developed such that it accesses the stored general description and a terminal-specific data record that describes the multimodal input possibilities and/or preferences of the terminal, and which according to the general description of the human-computer interaction and the multimodal input possibilities and/or preferences of the terminal creates at least one terminal-specific dialog coded in a second descriptive language, and that the computer system is equipped with a control unit to process the at least one dialog.

The invention is further achieved with a server of a computer system with at least one terminal, which is equipped with a user interface for a human-computer interaction between a user and the terminal, wherein the computer system is equipped with a memory unit in which a general declaratively written description of the human-computer interaction is stored coded in a first descriptive language, that the computer system is equipped with an interpreter, which is developed such that it accesses the stored general description and a terminal-specific data record that describes the multimodal input possibilities and/or preferences of the terminal, and which according to the general description of the human-computer interaction and the multimodal input possibilities and/or preferences of the terminal creates at least one terminal-specific dialog coded in a second descriptive language, and that the computer system is equipped with a control unit to process the at least one dialog.

The invention is further achieved with a terminal with a user interface for a human-computer interaction between a user and the terminal, wherein the server is equipped with a memory unit in which a general declaratively written description of the human-computer interaction is stored coded in a first descriptive language, that the server is equipped with an interpreter, which is developed such that it accesses the stored general description and a terminal-specific data record that describes the multimodal input possibilities and/or preferences of the terminal, and which according to the general description of the human-computer interaction and the multimodal input possibilities and/or preferences of the terminal creates at least one terminal-specific dialog coded in a second descriptive language.

The invention is based on the idea that a general declaratively written description of the human-computer interaction is coded, also covering possible multimodal aspects of the human-computer interaction. This coding is mapped to a terminal-specific coding, taking into account the specific multimodal capabilities of a terminal, by means of information technology methods.

The invention offers the advantage that an adaptable, automatically generated multimodal user interface is provided for a human-computer interaction. The human-computer interaction is thus automatically arranged in a particularly user-friendly way.

A further advantage of the invention is that one and the same coding of the human-computer interaction can be used for a number of different terminals. This increases the efficiency of the overall system.

An optimal result can thus be achieved each time with regard to modalities and terminals in changing environments.

The invention allows further forward-looking flexible terminals to be built, and applications to be developed for these, able to run on very different terminals and taking into account differing environmental conditions and modalities.

Advantageous developments of the invention can be taken from the subclaims.

The general declaratively written description is advantageously based on descriptive elements, which describe information to be obtained, information to be presented and rules, which specify relationships between the information to be presented and to be obtained. The general description is further advantageously based on descriptive elements that describe rules which specify the behavior of a dialog for different modalities and specify modality preferences for the presentation. This makes it possible to describe a human-computer interaction and its possible multimodal aspects in an effective way. The capability of the user interface for automatic adaptation to different terminals is also increased.

It is further advantageous that from the general declaratively written description an interpreter creates one or more terminal-specific dialogs according to terminal-specific rules of behavior and presentation, which are stored in a terminal-specific data record. This terminal-specific data record is further preferably modified on the basis of terminal-specific user behavior. This enables a particularly good adaptation of the user interface to the terminal and the modality.

It is especially effective in this connection if the interpreter assembles a dialog from dialog elements, which it selects, modifies and links according to the general description of the human-computer interaction and the multimodal input possibilities and/or preferences of the terminal. It is especially advantageous if the interpreter uses dialog elements to describe the dialog, which consist of a no-modality functional core that is supplemented by modality-specific properties. The work for the interpreter can thereby be reduced, so that the dialog can be created rapidly. The coding of this is especially simple if control objects and presentation objects are used as dialog elements.

### BRIEF DESCRIPTION OF THE DRAWINGS

The invention will be further described with reference to several examples of embodiments and with the help of the accompanying drawings.

FIG. 1 shows a block diagram of a computer system according to the invention with several servers according to the invention and several terminals according to the invention.

FIG. 2 shows a functional representation of the computer system according to the invention as in FIG. 1.

FIG. 3 shows a functional representation with several control objects and several presentation objects.

FIG. 4a shows a functional representation of a multimodal control object for a first embodiment.

FIG. 4b shows a functional representation of a multimodal control object for a second embodiment.

FIG. 5 shows a block diagram of a detail from the computer system according to FIG. 1 for a first embodiment.

FIG. 6 shows a block diagram of a detail from the computer system according to FIG. 1 for a second embodiment.

### DETAILED DESCRIPTION OF THE DRAWINGS

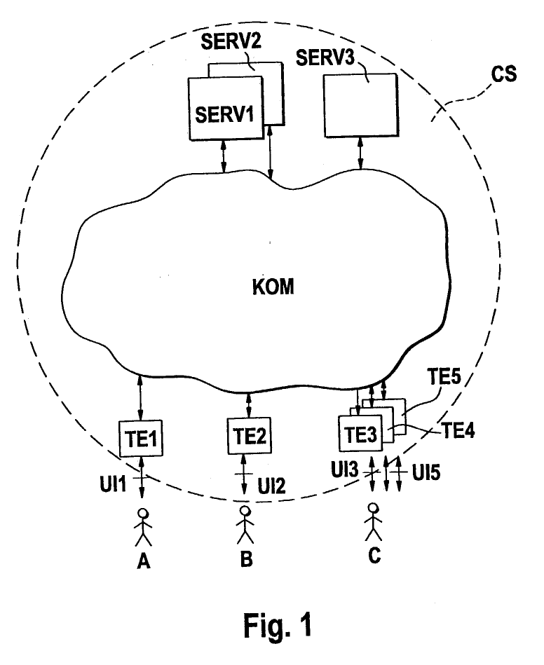

FIG. 1 shows a computer system CS with several servers SERV1 to SERV3, with a communication medium KOM, and with several terminals TE1 to TE5. The servers SERV1 to SERV3 communicate through the communication medium KOM with the terminals TE1 to TE5. The terminals TE1 to TE5 communicate through respective user interfaces UI1 to UI5 with users A, B or C.

The servers SERV1 to SERV3 each consist of one or more computers, a software platform based on this hardware, and, based on the software platform, application programs which control the functions of the servers SERV1 to SERV3.

The terminals TE1 to TE5 are computers or telecommunication terminals. For example, the terminals TE1 and TE2 are a GSM terminal (GSM=Global System for Mobil Communication) and a UMTS terminal (UMTS=Universal Mobile Communication). Terminals TE1 and TE2 are assigned to the users A and B respectively. Terminals TE3 to TE5 are assigned to the user C. The terminal TE3 for example is a computer. In this connection this computer can also take on the function of a client in relation to one of the servers SERV1 to SERV3. The terminal TE4 is a mobile computer. The terminal TE5 is a UMTS terminal.

The communication medium KOM provides a communication service for the communication between the servers SERV1 to SERV3 and the terminals TE1 to TE5. The communication medium KOM is a data network, for example. Such a data network preferably uses an IP protocol (IP=Internet Protocol) as layer 3 communications protocol. The use of the TCP/IP protocol stack is advantageous on the whole (TCP=Transmission Control Protocol). Used as transport networks are one or more LAN networks (LAN=Local Area Network), for example Ethernet networks, and/or backbone networks, for example ATM networks (ATM=Asynchronous Transfer Mode). But it is also possible for other telecommunications networks to be used as communication medium KOM. For example, ISDN networks (ISDN=Integrated Services Digital Network), PSTN networks (PSTN=Public Switched Telecommunication Network), mobile radio networks such as GSM networks, UMTS networks, DECT networks (DECT=Digital European Cordless Telecommunication), Wireless LAN networks or networks with a Bluetooth interface can be used for this. It is also possible that the communication medium is an interprocess communication service or a software bus, according to the Corba architecture for example (Corba=Common Object Request Broker Architecture).

It is also possible that data is exchanged between the servers SERV1 to SERV3 and the terminals TE1 to TE5 by means of a storage medium. Thus data can be saved from the server SERV1 to a storage medium, such as a CD-ROM, the storage medium then being physically transported to the terminal TE3 and the data being read in from the storage medium into the terminal TE3.

The terminals TE1 to TE5 each provide a user interface for a human-computer interaction between the individual user A, B and C and the respective assigned terminal. Thus the terminal TE1 provides a user interface UI1 to the user A, the terminal TE2 a user interface UI2 to the user B, and the terminals TE3 to TE5 a user interface UI3, UI4 or UI5 to the user C. The user interfaces UI1 to UI5 enable the users A, B and C to interact with the computer system CS or components of the computer system CS, and for example to send control commands to the computer system CS or elements of the computer system CS, and/or receive information from this or these.

A general declaratively written description of the human-computer interaction is stored coded in a first descriptive language in the computer system CS. In this connection it is possible that this general description is stored in one of the servers SERV1 to SERV3 or in one or more of the terminals TE1 to TE5.

The computer system CS also possesses one or more interpreters. This or these can be arranged in the servers SERV1 to SERV3 or the terminals TE1 to TE5. The interpreter accesses the stored general description and one or more terminal-specific data records, which describe the multimodal input possibilities and/or preferences of one or more of the terminals TE1 to TE5. Such a terminal-specific data record can be stored either in the respective assigned terminal or in one or more of the servers SERV1 to SERV3.

To supply the user interface UI1, an interpreter accesses the general declaratively written description of the human-computer interaction. It also accesses a terminal-specific data record, which describes the multimodal input possibilities and/or preferences of the terminal TE1. In accordance with the general description of the human-computer interaction and the terminal TE1's multimodal input possibilities and/or preferences, which it takes from the terminal-specific data record, the interpreter then creates at least one terminal-specific dialog coded in a second descriptive language. The at least one dialog thus created is then processed by a control unit.

It is possible here that the control unit is arranged in the terminal TE1 or in one of the servers SERV1 to SERV3. It is further advantageous that for each of the terminals TE1 to TE5, a terminal-specific data record, which describes the multimodal input possibilities and/or preferences of the terminals TE1, TE2, TE3, TE4 or TE5, is stored in the computer system CS.

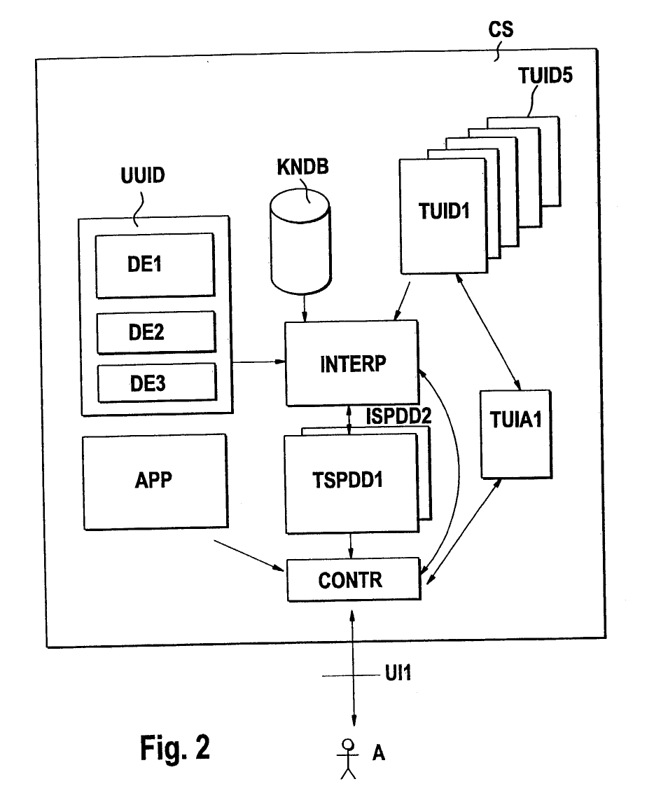

The functions of the method according to the invention are described in more detail below with reference to FIG. 2.

FIG. 2 shows the computer system CS and the user A. The computer system CS provides the user interface UI1 for a human-computer interaction between the user A and the terminal TE1.

A human-computer interaction represents an exchange of information between a person and a computer.

The computer system CS presents several data records UUID, KNDB, TUID1 to TUID5, and TSPDD1 to TSPDD2. The computer system CS further presents an interpreter INTERP, two control units CONTR and TUIAL and an application program APP.

The data records UUID, KNDB, TUID1 to TUID5 and TSPDD1 to TSPDD2 are stored or buffered in one or more memory units of the computer system CS. The interpreter INTERP and the control unit TUIA1 are each formed from an application program, which runs on one of the hardware components of the computer system CS. The control unit CONTR interprets the data records TSPDD1 and TSPDD2. It can be implemented in software as an application program, which runs on one of the hardware components of the computer system CS. A hardware implementation of the control unit CONTR is also possible.

The data record UUID consists of data, which contains a general declaratively written description of a human-computer interaction coded in a first descriptive language. In this context, declarative means that the description of the human-computer interaction does not specify fixed human-computer dialogs, but simply defines facts and rules that the dialogs of the human-computer interaction have to follow. For example, the description does not stipulate a particular font size for a heading, but simply stipulates that the heading has to be larger than the subsequent text.

A programming language such as C or Java can be used as the descriptive language for coding the description of the human-computer interaction. But it is also possible that descriptive languages such as XML (Extended Markup Language) or ASN.1 (Abstract Syntaxes Notation 1) are used.

The description of a human-computer interaction contained in the data record UUID declaratively describes one or more interactions between the application program APP running on the computer system, and a human user. But it is also possible that the declarative description contained in the data record also includes, in addition to the description of the user interface (i.e. the human-computer interaction), instructions for processing of information obtained. But it is advantageous to separate the description of the human-computer interaction on the one hand and the application on the other hand, as this makes the program structure clearer.

The general declarative description contained in the data record UUID is made up of various descriptive elements.

The first part DE1 of the description contains descriptive elements, which describe information to be obtained, information to be presented and rules, which specify relationships between the information to be presented and to be obtained. Information to be obtained is described, for example, by giving the name and the data type, e.g. “Name/String/20 characters”. Information to be presented is described, for example, by giving the name of the information type, e.g. text, table, graphic diagram, and the data source. Relationships between the information to be presented and to be obtained are, for example, affiliation (grouping), urgency of presentation, or relation to other descriptive elements, such as “supports”, “replaces” or “supplements”.

A second part DE2 of the description contains descriptive elements that describe rules which specify the behavior of the human-computer interaction for different modalities. These rules supplement general rules stored in the computer system CS with specific rules in relation to the specific human-computer interaction.

A third part DE3 of the description contains descriptive elements that describe rules describing modality preferences for the presentation of information for the human-computer interaction specified in the data record UUID.

The human-computer interaction can already be declaratively described by means of the descriptive elements of the part DE1. It is thus unnecessary to use descriptive elements of parts DE2 and DE3. It is advantageous that the descriptive elements of part DE1 make no specifications about which modality is used for presenting or obtaining information. Preferences and rules relating to modality aspects of the human-computer interaction are described with descriptive elements of parts DE2 and DE3.

The data record KNDB contains general behavior and presentation rules for dialogs. The rules included in the data record KNDB represent a general knowledge base, the behavior and presentation rules for dialogs included in it being generally valid for a large number of human-computer interactions. It is feasible in this connection that the computer system CS modifies or supplements the general rules in the course of time on the basis of experience, thereby achieving a “learning effect”.

The data records TUID1 to TUID5 represent terminal-specific data records, which are assigned to the terminals TE1, TE2, TE3, TE4 and TE5. They describe the multimodal input possibilities and/or preferences of the particular terminal to which they are individually assigned. It is further possible that the terminal-specific data records TUID1 to TUID5 contain terminal-specific behavior and presentation rules for dialogs. The data record TUID1, for example, describes the modalities by which a user can receive information from the terminal TE1, and the modalities by which a user can input information into the terminal TE1. It further describes which modalities are to be preferred for the input and/or output, dependent on which conditions.

The interpreter INTERP runs on the hardware of the computer system CS, and executes the general description coded in the data record UUID for the human-computer interaction. For this, the interpreter INTERP accesses the data record UUID with the general description, and one of the terminal-specific data records TUID1 to TUID5. The interpreter INTERP decides which of the terminals TE1 to TE5 a user interface for the human-computer interaction should be provided for, and from the terminal-specific data records TUID1 to TUID5 accesses the one assigned to this terminal. To supply the user interface UI1, the interpreter INTERP thus accesses data record TUID1.

When accessing the data records UUID and TUID1, the interpreter INTERP reads data from these data records. The interpreter INTERP further accesses the data record KNDB and reads data from this data record. Based on the data thus available to the interpreter, the interpreter then creates at least one terminal-specific dialog coded in a second descriptive language.

The first and second descriptive language can be identical. But it is advantageous that different descriptive languages are used as first and second descriptive languages. The descriptive languages named in relation to the first descriptive language are also possible in principle for the second descriptive language.

It is possible that several differing control units CONTR are provided within the computer system CS, each being assigned to different terminals. It is advantageous in this connection if the second descriptive language selected by the interpreter INTERP is a descriptive language adapted to the particular control unit CONTR addressed.

The data records TSPDD1 and TSPDD2 are generated by the interpreter INTERP and each describe one or more terminal-specific dialogs. The dialogs contained in the data records TSPDD1 and TSPDD2 are then processed by the control unit CONTR.

The general description contained in the data record UUID is thus processed in two steps: The dialog creation, which is performed by the interpreter INTERP, and the dialog processing, which is performed by the control unit CONTR.

It is possible here that only a part of the general description held in the data record UUID is processed at a time, and one or a few dialogs are created from this, and subsequently processed by the control unit CONTR. The remaining processing of the general description held in the data record UUID then only occurs after the processing of these dialogs, and based on the result of the processed dialogs. These results thus go into the creation of further dialogs by the interpreter INTERP. Dialog creation and dialog processing thus alternate successively.

It is also possible that the interpreter INTERP processes the entire general description held in the data record UUID and creates all dialogs at once. The data record TSPDD1 thus contains all dialogs to be processed by the control unit CONTR1.

The interpreter INTERP creates one or more terminal-specific dialogs based on descriptive elements of the general description, which are contained in the data record UUID, based on the general behavior and presentation rules for dialogs, which are contained in the data record KNDB, and based on the multimodal input possibilities and/or preferences for the terminal TE1, which are contained in the data record TUID1. The interpreter INTERP creates one or more terminal-specific dialogs, according to the information to be obtained and information to be presented as specified in the descriptive elements, and applying the rules specified in the descriptive elements and in the data records KNDB and TUID1.

It is advantageous in this connection that the interpreter assembles the dialog or dialogs from dialog elements, which it selects, modifies and links according to the general description of the human-computer interaction and the multimodal input possibilities and/or preferences of the terminal. Such dialog elements can be coded as objects, for example. The data records TSPDD1 and TSPDD2 thus contain an object-oriented representation of one or more dialogs. But it is also possible that the interpreter does not use an object-oriented descriptive language for coding the dialogs, and the dialog(s) created are not object-oriented.

It is advantageous that for describing the dialog the interpreter uses dialog elements which have a logical value that is decided by rules and can be used in rules. This enables the dialog description to be dynamic in design. To describe dialogs, it is further advantageous if the interpreter INTERP uses dialog elements which consist of a no-modality functional core that can be supplemented by modality-specific properties.

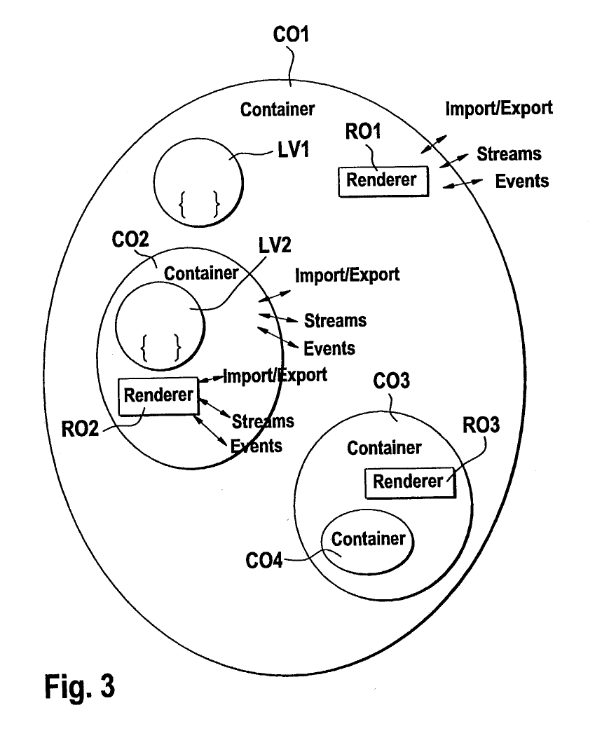

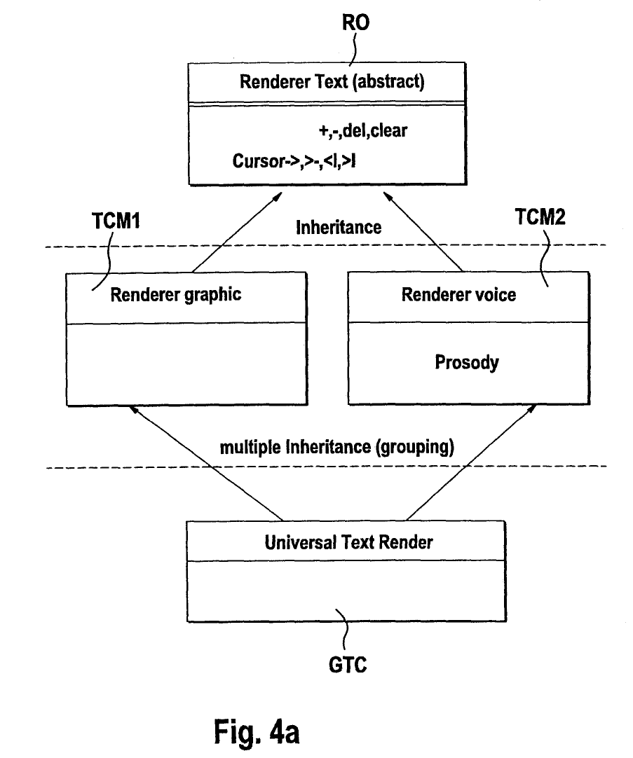

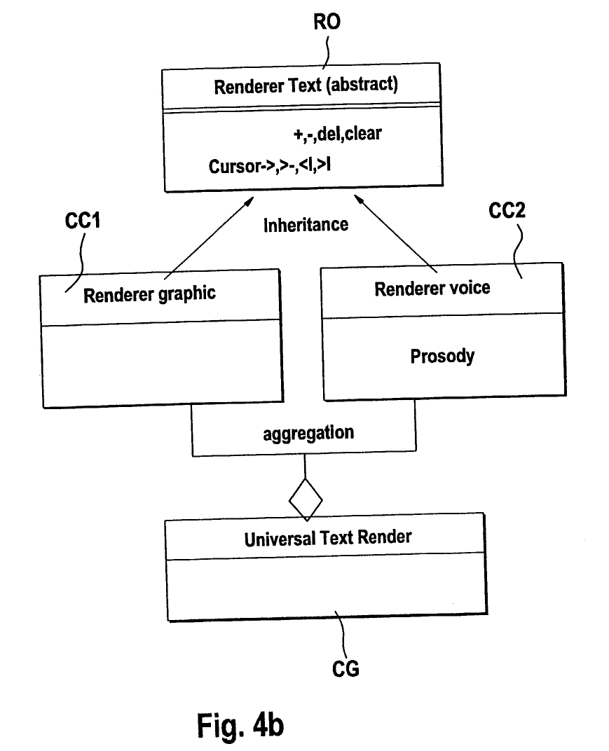

With reference to FIG. 3 and FIG. 4a, an explanation now follows for the functioning of a possible embodiment of the interpreter INTERP, in which the interpreter INTERP uses dialog elements to describe dialogs, which are formed from control objects and presentation objects.

FIG. 3 shows the principal structure of a dialog created by an interpreter INTERP, as it can be held coded in a second descriptive language in the data record TSPDD1 generated by the interpreter INTERP. The dialog is described by dialog elements, several of which dialog elements CO1 to CO4 and RO1 to RO3 are shown as examples in FIG. 3.

The dialog elements CO1 to CO4 are formed from control objects. Control objects are objects that contain and manage other objects within them, and do not need to have a physical representation.

The dialog elements RO1 to RO3 are formed from presentation objects. Presentation objects are objects that present or receive information by means of a modality, and have a representation in at least one modality.

As shown in FIG. 3, control objects can contain and manage other control objects and presentation objects. Thus for example the dialog element CO1 contains the dialog elements RO1, CO2 and CO3. The dialog element CO2 further contains the dialog element RO2, and the dialog element CO3 contains the dialog elements CO4 and RO3.

Dialog elements, i.e. presentation objects and control objects, possess a logical value, which is decided by rules. The logical value of a dialog element can itself be used in rules. The logical value of a dialog element is first defined in the presentation phase on the basis of the correlation of rules, preferences and properties. In FIG. 3 for example, two variables LV1 and LV2 are shown, which contain logical values of the dialog elements CO1 and CO2 respectively.

Control objects and presentation objects each have an interface over which variables can be imported/exported. Events and (data) streams can also be exchanged over this interface. This is shown in FIG. 3 for the dialog elements CO1, CO2 and RO2, for example.

Multimodal dialog elements are constructed according to the principle that they each have a no-modality functional core, which is supplemented by modality-specific properties in each case. This is shown in FIG. 4a.

FIG. 4a shows an example of the instantiation of a presentation object. A no-modality functional core GTC is supplemented by the interpreter INTERP with modality-specific properties TCM1 and TCM2, thus forming the presentation object RO. The no-modality functional core GTC is formed from a particular object class, in this case the object class “Universal Text Render”. This object class contains no modality-specific functions. The modality-specific properties TCM1 and TCM2 for their part are contained in specific object classes. Thus for example an object class “Renderer voice” contains modality-specific functions for the modality “Speech”. The object class “Renderer graphic” contains modality-specific functions for the modality “graphic representation”. The modality-specific properties TCM1 and TCM2 are formed from the instantiation of the object classes “Renderer voice” and “Renderer graphic”. The object classes “Renderer voice” and “Renderer graphic” are linked here by inheritances with the object class “Universal Text Render”. This means that the object classes “Renderer voice” and “Renderer graphic” can contain functions of the object class “Universal Text Renderer”.

To generate the presentation object RO, the interpreter INTERP instantiates the object classes “Universal Text Renderer”, “Renderer voice” and “Renderer graphic” according to the information and rules held in the general description, the data record KNDB and the data record TUID1.

The interpreter INTERP thus executes the following steps for dialog creation:

The interpreter INTERP first generates the first control object. Using the multimodal properties (input and output possibilities) and/or preferences of the terminal TE1 contained in the data record TUID1, the rules contained in the data record UUID and the rules contained in the data record KNDB, it then attempts to assign presentation objects to the information specified in the descriptive elements of the general description as to be obtained and to be output, and to tie them to the control object. If this is not possible, for example because the display cannot take place as the screen is too small or the processor capacity is inadequate, or because the rules define a particular grouping of information, then further control objects are generated or other modalities chosen. The process of tying the presentation objects to the control objects is then repeated. A backtracking approach is used in the search for the optimal solution. As well as the selection and linking of the control objects and presentation objects, these are modified by the interpreter INTERP according to the information and rules held in the data records UUID, KNDB and TUID1. As already presented above, these control objects and presentation objects can themselves contain rules, which are defined by the interpreter when the dialog is created. Such rules can trigger signals, which lead to the execution of other rules or external procedures. Events can further be assigned to such rules, to trigger the execution of these rules. It is advantageous in this connection that when a dialog is created, rules from the general description assigned to this dialog and from the global knowledge base containing the data record KNDB are used.

The dialog description thus generated by the interpreter INTERP by selection, modification and linking of control objects and presentation objects is stored by the interpreter INTERP, coded in a second descriptive language, in the data record TSPDD1.

If the interpreter has created the entire dialog, this is processed by the control unit CONTR, in that the information to be won is obtained from the user and/or the dialog is aborted by the user or the system. The rules coded in the dialog, which control the interaction with the user, are also applied here.

The control unit TUIA1 from FIG. 2 modifies the terminal-specific data records TUID1 to TUID5 based on the terminal-specific or subscriber-specific user behavior. The control unit TUIA1 monitors the behavior of the users of terminals TE1 to TE5 for this. From the relevant terminal-specific user behavior, the control unit TUIAL determines the users' preferences for these terminals. If the preferences thus determined do not tally with the preferences coded in the data records TUID1 to TUID5 for the terminals TE1 to TE5, the preferences coded in the data records TUID1 to TUID5 are amended according to the preferences found.

FIG. 4b shows an example of a further possible instantiation of the presentation object RO by the interpreter INTERP.

FIG. 4b shows the presentation object RO and three object classes CG, CC1 and CC2.

As well as the functions and data of the no-modality functional core, the object class CG also contains all modality-specific functions. As well as the functions and data of the no-modality functional core, the object class CC1 contains the modality-specific functions for the modality “Speech”. As well as the functions and data of the no-modality functional core, the object class CC2 contains the modality-specific functions for the modality “Graphic representation”. The object class CG thus represents a super-class, which includes the functions and data of the object classes CC1 and CC2.

To generate the presentation object RO, the interpreter INTERP instantiates one of the object classes CC1, CC2 or CG according to the information and rules held in the general description, the data record KNDB and the data record TUID1.

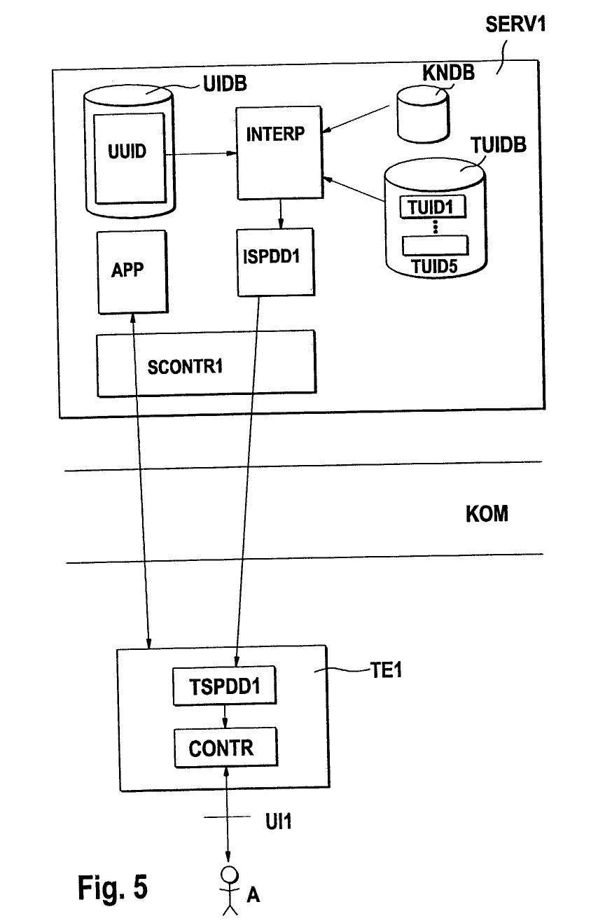

With reference to FIG. 5, the structure of a server according to the invention will now be elucidated as an example.

FIG. 5 shows the server SERV1, the communication medium KOM, the terminal TE1 and the user A, who communicates over the user interface UI1 with the terminal TE1.

As already presented above, the server SERV1 is composed of a hardware platform formed from one or more interconnected computers, a software platform based on this hardware platform, and application programs based on this software platform. As a result of the execution of one or more of these application programs on the software and hardware platform of the server SERV1, the functions described below of the server SERV1 are performed.

The server SERV1 performs the function of an Internet, WAP, and/or UMTS server (WAP=Wireless Application Protocol), which supplies UMTS, WAP, and/or UMTS services to terminals. The server SERV1 is faced with the problem of having to interact with service users through a large number of very differently developed terminals to provide services. For the most optimal adaptation of the user interface to the service it has provided to the terminal actually accessing it, the server SERV1 generates for each accessing terminal a user interface individually tailored to the requested service and the accessing terminal.

From the functional angle, the server SERV1 presents for this the interpreter INTERP, the control unit SCONTR1, the application program APP and the data records UUID, KNDB, TSPDD1, and TUID1 to TUID5.

The data record UUID is stored in a memory unit UIDB. The data records TUID1 to TUID5 are stored in a memory unit TUIDB. The memory units UIDB and TUIDB are databases. It is possible here that the data records UUID, KNDB and TUID1 to TUID5 are stored in one and the same database.

The control unit SCONTR1 controls the performance of a service provided by the server SERV1. The service logic is coded in the application program APP. The data record UUID contains the general declaratively written description of the human-computer interactions, which are to be executed for the interaction between service user and service in performance of the service. The data record UUID thus contains the general description of the user interface between a service user and the service logic coded in the application program APP.

The data records UUID, KNDB, TSPDD1 and TUID1 to TUID5 contain the information described according to FIG. 2 to FIG. 4. The interpreter INTERP likewise performs the functions according to FIG. 2 to FIG. 4.

The terminal TE1 presents the control unit CONTR and a copy of the data record TSPDD1. The control unit CONTR also performs the functions according to FIG. 2 to FIG. 4.

The control unit SCONTR1 controls the performance of the service whose service logic is coded in the application program APP. If performance of the service is now requested from the terminal TE1, the control unit SCONTR1 instructs the interpreter INTERP to create one or more dialogs for the interaction with the service user, in this case user A. The control unit SCONTR1 further informs the interpreter INTERP of the terminal from which the service was requested. The interpreter INTERP accesses the general description stored in the memory unit UIDB, and the terminal-specific data record assigned to the requesting terminal. In this embodiment, the service was requested from the terminal TE1, and the interpreter thus accesses the data record UUID and the data record TUID1, which describes the multimodal input possibilities and/or preferences of the terminal TE1. According to the general description of the human-computer interaction contained in the data record UUID and the multimodal input possibilities and/or preferences of the terminal TE1 contained in the data record TUID1, the interpreter then creates at least one terminal-specific dialog coded in a second descriptive language. As described in the embodiments according to FIG. 2 to FIG. 4, the interpreter thus creates the data record TSPDD1, which contains such a dialog. The data record TSPDD1 created by the interpreter INTERP is now transmitted by the control unit SCONTR1 to the terminal TE1 and stored there.

The control unit CONTR now processes the dialog(s) contained in the data record TSPDD1. The result(s) of this processing are transmitted by the control unit CONTR to the control unit SCONTR1, which evaluates the results according to the service logic contained in the application program APP.

As already presented above, the interpreter INTERP can create the dialogs for the human-computer interaction successively, while evaluating the information received from the control unit CONTR. But it is also possible that the interpreter INTERP creates all the dialogs for the human-computer interaction and the control unit SCONTR1 sends one data record to the terminal TE1, containing all necessary terminal-specific dialogs coded in the second descriptive language. It is further possible that the application program APP, as described above, is not separated from the general description of the human-computer interaction contained in the data record UUID.

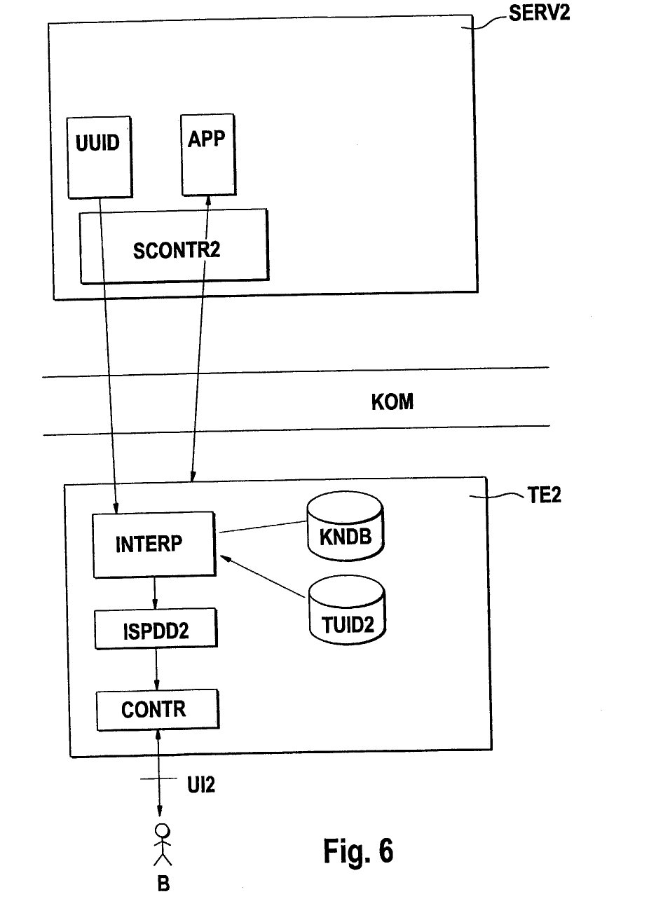

With reference to FIG. 6, a further embodiment of the invention is now explained.

FIG. 6 shows the server SERV2, the communication medium KOM, the terminal TE2 and the user B, who communicates over a user interface UI2 with the terminal TE2.

The server SERV2 is similar in structure to the server SERV1 according to FIG. 5, with the difference that the interpreter INTERP is arranged in the terminal TE2, not in the server SERV2. As elements essential to the function, the server SERV2 thus presents only a memory unit with the data record UUID and the application program APP, along with the control unit SCONTR2.

Upon a service request from the terminal TE2, which requests from the server SERV2 the provision of a service, whose service logic is coded in the application program APP, the control unit SCONTR2 sends the data record UUID to the terminal TE2. The results of the human-computer interaction performed by the terminal TE2 are transmitted from the terminal TE2 to the control unit SCONTR2, which evaluates these according to the application program APP for provision of the service.

It is possible here that several data records, which contain a general declaratively written description of a human-computer interaction coded in a first descriptive language, are transmitted successively from the control unit SCONTR2 to the terminal TE2.

The terminal TE2 presents a processor and a memory unit as well as peripheral components. These peripheral components enable the interaction of the terminal TE2 through the communication medium KOM, for one thing. These peripheral components further enable the terminal TE2 to communicate with a user through one or more modalities.

The data records KNDB and TUID2 are stored in the memory unit of the terminal TE2. It is further advantageous that in the memory unit of terminal TE2 the data record UUID received from the server SERV2 is also stored.

Also stored in the memory unit of terminal TE2 is a computer program, which performs the functions of the interpreter INTERP and the control unit CONTR according to FIGS. 2 to 4 when it is executed by the processor of the terminal TE2.

Upon receipt of a data record, which presents a general declaratively written description of a human-computer interaction coded in a first descriptive language, this general description is stored in the memory unit of the terminal TE2. Thus when the data record UUID is received, this data record is stored in the memory unit of the terminal TE2. The interpreter INTERP now accesses this general description and the data record TUID2, which describes the multimodal input possibilities and/or preferences of the terminal TE2. In accordance with the general description of the human-computer interaction and the terminal TE2's multimodal input possibilities and/or preferences, the interpreter INTERP then creates at least one terminal-specific dialog coded in a second descriptive language. According to this embodiment, the interpreter INTERP creates for this the data record TSPDD2, which contains such a dialog.

The control unit CONTR processes the at least one dialog thus created. It is possible in this connection that the function of the control unit CONTR is synchronized with the function of the interpreter INTERP, so that there is no need to store the data record TSPDD2.

1. Method for providing a user interface for a human-computer interaction between a user and a terminal, wherein a general declaratively written description of the human-computer interaction is stored coded in a first descriptive language, that an interpreter accesses the stored general description and a terminal-specific data record, which describes the multimodal input possibilities and/or preferences of the terminal and the interpreter according to the general description of the human-computer interaction and the multimodal input possibilities and/or preferences of the terminal creates at least one terminal-specific dialog coded in a second descriptive language, and that the at least one dialog thus created is processed by a control unit.

2. Method as claimed in claim 1, wherein the interpreter creates the dialog based on the descriptive elements of the general description, which describe information to be obtained, information to be presented and rules, which specify relationships between the information to be presented and to be obtained.

3. Method as claimed in claim 2, wherein the interpreter creates a dialog based on descriptive elements of the general description, which describe rules that specify the behavior of the human-computer interaction for different modalities.

4. Method as claimed in claim 2 or 3, wherein the interpreter creates the dialog based on descriptive elements of the general description, which describe rules that specify the modality preferences of the presentation of information.

5. Method as claimed in claim 1, wherein the interpreter, to create the at least one dialog accesses a data record, which specifies general rules of behavior and presentation for dialogs, and the interpreter creates the at least one dialog according to these general rules of behavior and presentation.

6. Method as claimed in claim 1, wherein the terminal-specific data record accessed by the interpreter for creating the at least one dialog specifies terminal-specific rules of behavior and presentation for dialogs, and the interpreter creates the at least one dialog according to these terminal-specific rules of behavior and presentation.

7. Method as claimed in claim 1, wherein the terminal-specific data record is modified on the basis of the terminal-specific user behavior.

8. Method as claimed in claim 1, wherein the interpreter assembles the at least one dialog from dialog elements, which it selects, modifies and links according to the general description of the human-computer interaction and the multimodal input possibilities and/or preferences of the terminal.

9. Method as claimed in claim 1, wherein the interpreter uses dialog elements to describe the dialog, which have a logical value that is determined by rules and can be used in rules.

10. Method as claimed in claim 1, wherein the interpreter uses dialog elements to describe the dialog, which consist of a no-modality functional core that is supplemented by modality-specific properties.

11. Method as claimed in claim 1, wherein the interpreter uses dialog elements to describe the dialog, which are formed from control objects and presentation objects.

12. Method as claimed in claim 1, wherein different descriptive languages are used as first and second descriptive language.

13. Computer system with at least one terminal, which is equipped with a user interface for a human-computer interaction between a user and the terminal, wherein the computer system is equipped with a memory unit in which a general declaratively written description of the human-computer interaction is stored coded in a first descriptive language, that the computer system is equipped with an interpreter, which is developed such that it accesses the stored general description and a terminal-specific data record that describes the multimodal input possibilities and/or preferences of the terminal, and which according to the general description of the human-computer interaction and the multimodal input possibilities and/or preferences of the terminal creates at least one terminal-specific dialog coded in a second descriptive language, and that the computer system is equipped with a control unit to process the at least one dialog.

14. Server of a computer system with at least one terminal, which is equipped with a user interface for a human-computer interaction between a user and the terminal, wherein the server is equipped with a memory unit in which a general declaratively written description of the human-computer interaction is stored coded in a first descriptive language, that the server is equipped with an interpreter, which is developed such that it accesses the stored general description and a terminal-specific data record that describes the multimodal input possibilities and/or preferences of the terminal, and which according to the general description of the human-computer interaction and the multimodal input possibilities and/or preferences of the terminal creates at least one terminal-specific dialog coded in a second descriptive language.

15. Terminals with a user interface for a human-computer interaction between a user and a terminal, wherein the terminal is equipped with an interpreter that is developed such that it accesses a general declaratively written description of the human-computer interaction coded in a first descriptive language and a terminal-specific data record, which describes the multimodal input possibilities and/or preferences of the terminal, that the interpreter is further developed such that according to the general description of the human-computer interaction and the multimodal input possibilities and/or preferences of the terminal creates at least one terminal-specific dialog coded in a second descriptive language, and that the terminal is equipped with a control unit for processing the at least one dialog.
